(19) United States
(12) Patent Application Publication
(10) Pub. No.: US 2005/0262047 A1
(43) Pub. Date: Nov. 24, 2005

(54) Apparatus and method for inserting portions of reports into electronic documents

(76) Inventors: Ju Wu, Coquitlam (CA); Qian Wu, Anmore (CA)

Correspondence Address: COOLEY GODWARD, LLP, 3000 EL CAMINO REAL, 5 PALO ALTO SQUARE, PALO ALTO, CA, 94306, US

(21) Appl. No.: 11/137,710

(22) Filed: May 24, 2005

Related U.S. Application Data
(63) Continuation-in-part of application No. 10/335,079, filed on Dec. 31, 2002.

(51) Int. Cl. G06F 17/30

(52) U.S. Cl. 707/2

(57) ABSTRACT

The invention includes a computer-readable medium comprising executable instructions to generate a set of reports through access to a data source. A selected report from the set of reports is specified. A report part is extracted from the selected report. The report part is augmented with metadata. The report part is then inserted within an electronic document.

### CROSS REFERENCE TO RELATED APPLICATIONS

This application is a continuation-in-part of the pending application entitled “Apparatus and Method for Delivering Portions of Reports”, U.S. Ser. No. 10/355,079, filed Dec. 21, 2002.

### BRIEF DESCRIPTION OF THE INVENTION

The present invention relates generally to delivering electronic reports. More particularly, the present invention relates to delivering specific portions of electronic reports.

### BACKGROUND OF THE INVENTION

There are a number of commercially available products to produce reports from stored data. For instance, Business Objects Americas, Inc. of San Jose, Calif., sells a number of widely used report generation products, including Crystal Reports™, Crystal Analysis™, and Crystal Enterprise™. As used herein, the term report refers to information automatically retrieved (i.e., in response to computer executable instructions) from a data source (e.g., a database, a data warehouse, and the like), where the information is structured in accordance with a report schema that specifies the form in which the information should be presented. As discussed below, a portion of a report refers to a subset of the information retrieved from the data source; typically, the subset of information maintains the structure specified by the report schema.

In many instances, reports are designed to have salient information as well as detailed information. Some users may wish to view a report in its entirety, while other users may wish to simply view the salient information included in the report. However, previous reporting approaches generally lack sufficient flexibility to deliver a specific portion of a report that may be of interest to a user. Rather, previous reporting approaches often delivered a report in its entirety or an entire page of the report at a time. Moreover, some users may wish to view specific portions of one or more reports. However, previous reporting approaches sometimes lack the ability to effectively link specific portions of one or more reports to provide a navigation path through the one or more reports.

Also, a report can include a number of elements such as, for example, a chart, a map, and the like. Certain devices such as cellular phones may not be able to properly display such a report. In accordance with previous reporting approaches, report designers often had to produce reports that were tailored for specific devices. Such approaches are time consuming and expensive, since multiple reports that contain similar information have to be produced.

At times it may be desirable to insert a specific portion of a report into another electronic document, such as another report or a non-report. A non-report is an electronic document that is constructed without the automatic retrieval (i.e., in response to computer executable instructions) of information from a data source. Examples of non-report electronic documents include typical business application documents, such as a word processor document, a spreadsheet document, a presentation document, and the like. In these documents, manual intervention is typically required to establish content and formatting. Presently, it is difficult to insert a specific portion of a report into another electronic document.

It is against this background that a need arose to develop the apparatus and method described herein.

### SUMMARY OF THE INVENTION

The invention includes a computer-readable medium comprising executable instructions to specify a selected report. A report part is chosen from the selected report. The report part is then inserted into an electronic document.

The invention also includes a computer-readable medium comprising executable instructions to select a report part from an existing report. The report part is augmented with metadata characterizing a report part source report and data context. The report part is then inserted into an electronic document. Report part data is refreshed within the electronic document.

The invention includes a computer-readable medium comprising executable instructions to generate a set of reports through access to a data source. A selected report from the set of reports is specified. A report part is extracted from the selected report. The report part is augmented with metadata. The report part is then inserted within an electronic document.

### BRIEF DESCRIPTION OF THE DRAWINGS

For a better understanding of the nature and objects of the invention, reference should be made to the following detailed description taken in conjunction with the accompanying drawings, in which:

FIG. 1 illustrates a computer network that may be operated in accordance with an embodiment of the invention.

FIG. 2 illustrates processing operations associated with an embodiment of the invention.

FIG. 3 illustrates two reports according to an embodiment of the invention.

FIG. 4 illustrates an example of a user-interface screen that may be provided by a report parts tool according to an embodiment of the invention.

FIG. 5 illustrates another example of a user-interface screen that may be provided by a report parts tool according to an embodiment of the invention.

FIG. 6 illustrates a sequence of user-interface screens showing navigation functionality in accordance with an embodiment of the invention.

FIG. 7 illustrates an implementation of navigation functionality according to an embodiment of the invention.

FIG. 8 illustrates an implementation of navigation functionality according to another embodiment of the invention.

FIG. 9 illustrates an implementation of navigation functionality according to a further embodiment of the invention.

FIG. 10 illustrates an implementation of navigation functionality according to yet a further embodiment of the invention.

FIG. 11 illustrates an embodiment of report part functionally in which a report part is embedded into an electronic document while maintaining links to the original report source.

FIG. 12 illustrates an embodiment of the system to insert report parts within electronic documents, such as applications and non-report documents.

FIG. 13 illustrates an embodiment of report part functionally in which a report part embedded in an electronic document is updated with new parameters or drilled down on.

FIG. 14 illustrates an embodiment of report part functionally in which a report part embedded in an electronic document has its data refreshed either from a report instance or database.

Like reference numerals refer to corresponding parts throughout the several views of the drawings.

### DETAILED DESCRIPTION

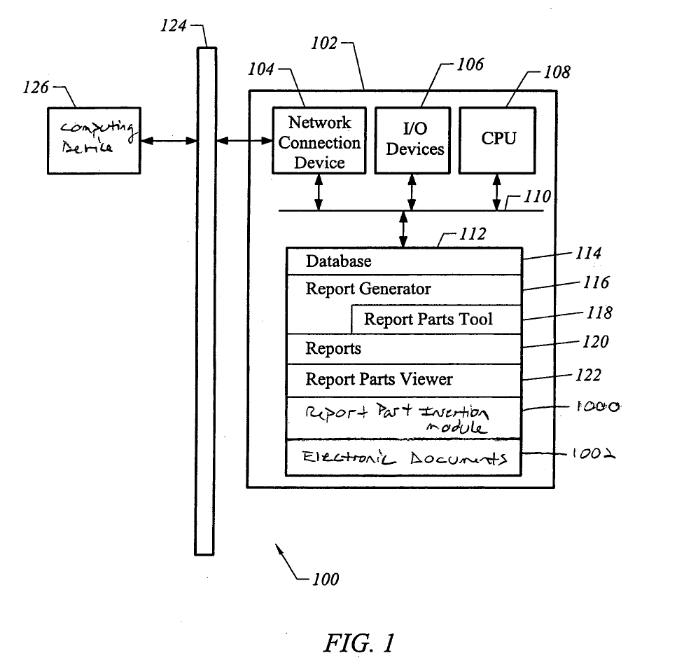

FIG. 1 illustrates a computer network 100 that may be operated in accordance with an embodiment of the invention. The computer network 100 includes a computer 102, which, in general, may be a client computer or a server computer. In the present embodiment of the invention, the computer 102 is a server computer including conventional server computer components. As shown in FIG. 1, the computer 102 includes a Central Processing Unit (“CPU”) 108 that is connected to a network connection device 104 and a set of input/output devices 106 (e.g., a keyboard, a mouse, a video monitor, a printer, a speaker, and so forth) via a bus 110. The network connection device 104 is connected to a network transport medium 124, which may be any wired or wireless transport medium.

The CPU 108 is also connected to a memory 112 via the bus 110. The memory 112 stores a set of executable programs. One executable program is a report generator 116. The report generator 116 can utilize standard techniques to produce a set of reports 120. In particular, the report generator 116 can access a database 114 resident in the memory 112 to produce the set of reports 120. Each report of the set of reports 120 can include one or more report objects. A report object refers to a particular portion of a report. In some instances, a report object refers to a particular portion of a report that contains related information. A report object can correspond to, for example, a summary field, a detail field, a chart, a map, a bitmap, a crosstab, a text block, a group name, or a combination thereof.

Referring to FIG. 1, the report generator 116 includes a report parts tool 118. In contrast to previous approaches, the report parts tool 118 provides functionality to allow a specific portion of a report to be viewed without the rest of the report. In particular, the report parts tool 118 can configure one or more report objects to be displayed in the absence of the rest of a report. For instance, a report can be a sales report that includes a chart and various summary and detail fields. For certain applications, it may not be desirable or feasible to view the entire sales report or an entire page of the sales report. In the present example, the report parts tool 118 can configure the chart to be displayed without the rest of the sales report. As another example, the report parts tool 118 can configure a summary or a detail field to be displayed without the rest of the sales report. The report parts tool 118 allows flexibility in delivering a specific portion of a report that can be tailored for a particular user. In the present embodiment of the invention, the report parts tool 118 facilitates linking of a report object included in one report to other report objects included in the same report or in different reports. Linking of report objects can create a navigation path through one or more reports, such that specific report objects can be displayed along the navigation path.

In the present embodiment of the invention, the report parts tool 118 can operate in conjunction with a report parts viewer 122. Unlike conventional report viewers, the report parts viewer 122 allows a user to view a specific portion of a report without the rest of the report. In particular, the report parts viewer 122 facilitates display of a set of report objects configured using the report parts tool 118. As discussed previously, various report objects can be linked to create a navigation path, and the report parts viewer 122 can coordinate navigation requests from a user with specific report objects to be displayed along the navigation path. In the present embodiment of the invention, the report parts viewer 122 can be integrated with Internet applications and wireless applications. In particular, the report parts viewer 122 can facilitate display of a set of report objects in applications such as, for example, portals or digital dashboards.

The report parts viewer 122 may be executed to display a set of report objects using, for example, a video monitor included in the set of input/output devices 106. Alternatively, or in conjunction, the report parts viewer 122 may be executed to allow a set of report objects to be displayed on a computing device 126. The computing device 126 may be a client computer, including conventional client computer components, or a portable computing device, including conventional portable computing device components. Examples of portable computing devices include personal digital assistants (“PDAs”), two-way pagers, and cellular phones. Unlike previous approaches, the report parts viewer 122 need not deliver data associated with an entire report or an entire page of the report to the computing device 126, which may not be able to properly process such data. Rather, the report parts viewer 122 can deliver data associated with a specific portion of the report to be displayed. The report parts viewer 122 can deliver different portions of a report to different types of computing devices, thereby avoiding the need to produce multiple reports for the different types of computing devices.

While the database 114, the report generator 116, the report parts tool 118, the set of reports 120, and the report parts viewer 122 are shown residing in the single computer 102, it should be recognized that such configuration is not required in all applications. For instance, one or more of these elements may reside in the computing device 126 or in a separate computer (not shown in FIG. 1) that is connected to the network transport medium 124.

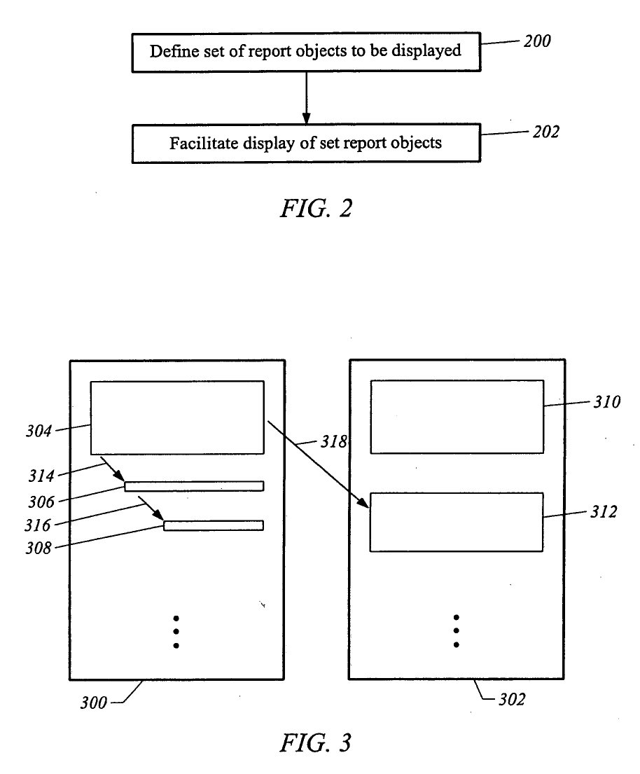

FIG. 2 illustrates processing operations associated with an embodiment of the invention. Initially, a set of report objects to be displayed is defined (block 200). The set of report objects can be included in a single report or in multiple reports.

By way of example, FIG. 3 illustrates two reports 300 and 302 according to an embodiment of the invention. Each report includes various report objects. In particular, the report 300 includes report objects 304, 306, and 308, and the report 302 includes report objects 310 and 312. Various report objects included in a report can be arranged in a hierarchy. For instance, the report object 304 can correspond to a chart showing total sales figures for various employees, the report object 306 can correspond to a summary field showing total sales figures for a particular employee, and the report object 306 can correspond to a detail field showing sales figures in a particular geographical region for a particular employee. For certain applications, multiple instances of a particular report object can be defined. For instance, multiple instances of the report object 306 can correspond to summary fields showing total sales figures for various employees, and multiple instances of the report object 308 can correspond to detail fields showing sales figures in various geographical regions for various employees.

A report object (e.g., the report object 306) included in a report can be associated with a set of report object parameters. Examples of report object parameters include:

1. Report Uniform Resource Identifier (“URI”)—This parameter indicates the report that includes the report object;

2. Report Object Name—This parameter indicates a name of the report object; and

3. Data Context—This parameter indicates one or more instances of the report object.

A report parts tool (e.g., the report parts tool 118) can configure a first report object of a set of report objects included in a first report as an initial report object. In the example shown in FIG. 3, the report object 304 can be configured as an initial report object. In some instances, an initial report object can correspond to a report object that is initially displayed along a particular navigation path. For certain applications, the report parts tool can configure the first report object as an initial report object by creating an indication of the first report object as an initial report object. Such an indication can be created by specifying one or more report object parameters of the first report object and can be stored along with the first report as a property of the first report.

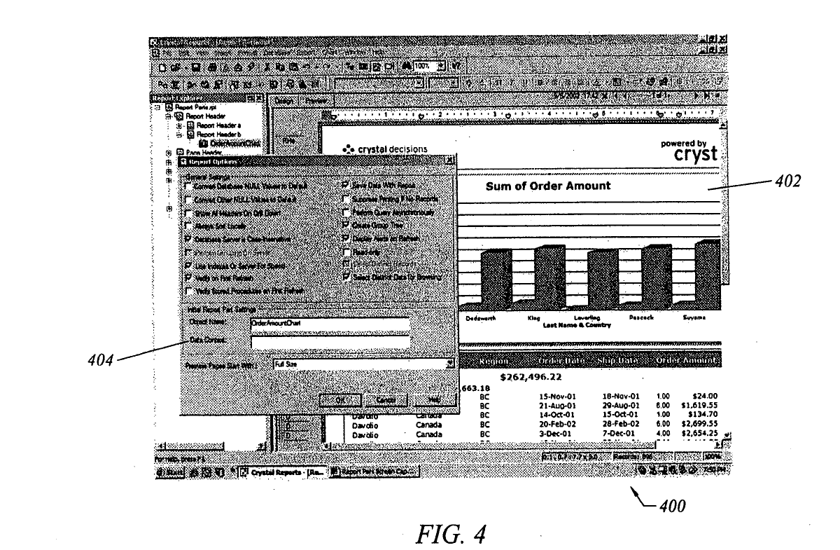

FIG. 4 illustrates an example of a user-interface screen 400 that may be provided by a report parts tool (e.g., the report parts tool 118) according to an embodiment of the invention. The user-interface screen 400 indicates various report objects included in a report. In this example, a report object 402 named as “OrderAmountChart” is selected. The user-interface screen 400 indicates a window 404 labeled as “Report Options”, and one or more report object parameters of the report object 402 can be specified to configure the report object 402 as an initial report object.

A report parts tool (e.g., the report parts tool 118) can configure a second report object as a destination report object, which second report object can be associated with a first report object included in the same or a different report. A destination report object can correspond to a report object that is subsequently displayed along a particular navigation path. Multiple destination report objects can be configured, and the multiple destination report objects can be sequentially or simultaneously displayed along a particular navigation path. For certain applications, the report parts tool can configure a second report object as a destination report object by creating a navigation link between a first report object and the second report object. Such a navigation link can be created by specifying one or more report object parameters of the second report object and can be stored along with a report as a property of the report. In the example shown in FIG. 3, the report object 306 can be configured as a destination report object that is associated with the report object 304 via a navigation link 314. As discussed previously, various report objects included in the report 300 can be arranged in a hierarchy, and linking of report objects at different levels of the hierarchy (e.g., the report objects 304 and 306) allows for drill-down functionality. In a similar manner, the report parts tool facilitates linking of report objects included in different reports. With reference to FIG. 3, the report object 312 can be configured as a destination report object that is associated with the report object 304 via a navigation link 318.

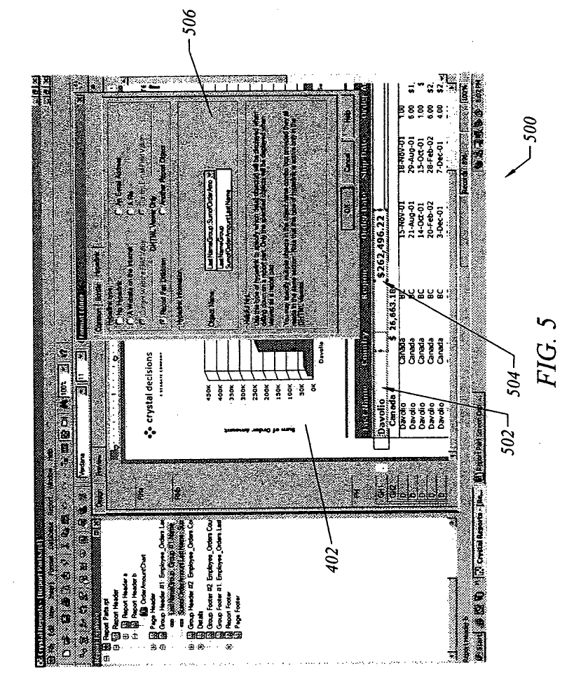

FIG. 5 illustrates another example of a user-interface screen 500 that may be provided by a report parts tool (e.g., the report parts tool 118) according to an embodiment of the invention. In this example, the report object 402 can be configured as an initial report object as discussed in connection with FIG. 4. Referring to FIG. 5, two report objects 502 and 504 named as “LastNameGroup” and “SumOrderAmountLastName” are selected. The user-interface screen 500 indicates a window 506 labeled as “Format Editor”, and one or more report object parameters of the report objects 502 and 504 can be specified to configure the report objects 502 and 504 as destination report objects that are associated with the report object 402.

If desired, navigation functionality can be enhanced by further linking report objects. In the example shown in FIG. 3, the report object 308 can be configured as an additional destination report object that is associated with the report object 306 by creating a navigation link 316.

Returning to FIG. 2, the next processing operation is to facilitate the delivery and ultimate display of the set of report objects (block 202). A report parts viewer (e.g., the report parts viewer 122) can facilitate the delivery and display of the set of report objects. In the present embodiment of the invention, the report parts viewer can coordinate a request to view a first report with a first report object of a set of report objects included in the first report. In particular, in response to the request to view the first report, the report parts viewer can identify the first report object as an initial report object. Such identification can be based on, for example, an indication of the first report object as an initial report object. The report parts viewer can then facilitate display of the first report object absent each remaining report object included in the first report. For certain applications, the report parts viewer can deliver data associated with the first report object to a computing device (e.g., the computing device 126), which can display the first report object.

As discussed previously, various report objects can be linked to create a navigation path, and the report parts viewer can coordinate navigation requests with specific report objects to be displayed along the navigation path. For instance, the report parts viewer can coordinate a navigation request for the first report object with a second report object included in the same report. In particular, in response to the navigation request, the report parts viewer can identify the second report object as a destination report object. Such identification can be based on, for example, a navigation link between the first report object and the second report object. Multiple instances of the second report object can be defined, and the report parts viewer can facilitate navigation to one or more instances of the second report object by passing an appropriate data context to the second report object. The report parts viewer can then facilitate display of the second report object absent each remaining report object included in the first report. For certain applications, the report parts viewer can deliver data associated with the second report object to a computing device (e.g., the computing device 126), which can display the second report object.

Alternatively, or in conjunction, the report parts viewer can coordinate a navigation request for the first report object with a second report object of a set of report objects included in a second report. As discussed previously, the report parts viewer can facilitate navigation to one or more instances of the second report object by passing an appropriate data context to the second report object. The report parts viewer can then facilitate display of the second report object absent each remaining report object included in the second report.

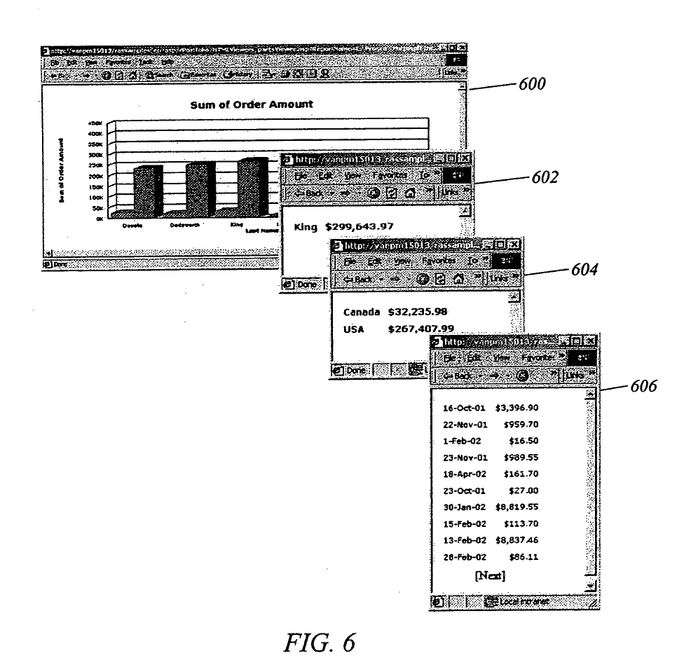

FIG. 6 illustrates a sequence of user-interface screens 600, 602, 604, and 606 in accordance with an embodiment of the invention. The sequence of user-interface screens 600, 602, 604, and 606 can be displayed on a computing device (e.g., the computing device 126) using a report parts viewer (e.g., the report parts viewer 122). As shown in FIG. 6, a set of report objects included in a report can be displayed along a particular navigation path. Here, the report objects can be arranged in a hierarchy, and the sequence of user-interface screens 600, 602, 604, and 606 provides an example of drill-down functionality.

Attention next turns to specific embodiments of the invention to further illustrate features and advantages of the invention. As discussed previously, a report object can be associated with a set of report object parameters, which can include a report URI, a report object name, and a data context.

A data context of a report object can indicate one or more hierarchy levels associated with a report and can define a region in the report in which one or more instances of the report object can be located. For certain applications, a data context of a report object can be specified using a format similar to Xpath (e.g., /USA or /USA/CA) or using a strongly-typed format (e.g., /Country[USA] or /Country[USA]/Region[CA]). A data context of a detail-level report object can be specified using a record number-based format (e.g., /Country[USA]/Region[CA]/RecordNumber[4]). All instances of a report object can be specified using a special character such as “*” (e.g., /Country[USA]/Region[*]). For certain applications, a data context of a report object can be specified using a formula-based format (e.g., “/”+{Table.Field} or “/”+{Table.Field}+“/”+{Table.Field}).

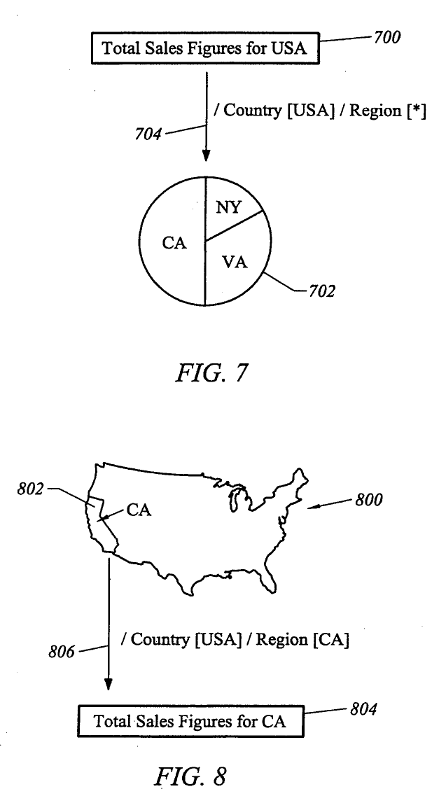

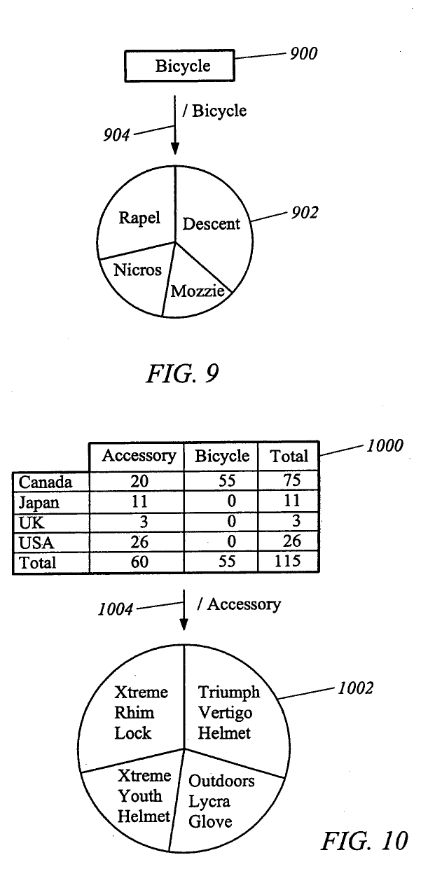

FIG. 7, FIG. 8, FIG. 9, and FIG. 10 illustrate implementations of navigation functionality according to various embodiments of the invention. In accordance with the navigation functionality as described herein, a first report object can be linked to a second report object. In response to a navigation request for the first report object, an appropriate data context can be produced, and the produced data context can be passed to the second report object to retrieve a relevant instance (or relevant instances) of the second report object.

Referring to FIG. 7, drill-down functionality is shown for report objects 700 and 702, which can be included in the same report. The report object 700 corresponds to a summary field showing total sales figures for a particular country (e.g., USA), and the report object 702 corresponds to a chart showing percentage contributions to total sales figures for various regions (e.g., CA, NY, and VA) within a particular country (e.g., USA). A report parts tool (e.g., the report parts tool 118) can be used to create a navigation link 704 between the report object 700 and the report object 702. In particular, the report object 702 can be configured as a destination report object (e.g., a drill-down report object) that is associated with the report object 700, and certain report object parameters (e.g., a report URI and a report object name) of the report object 702 can be associated with the report object 700 and stored as a property of the report.

When a user drills-down from the report object 700, a report parts viewer (e.g., the report parts viewer 122) can identify a data context of the report object 700 (e.g., /Country[USA]). The report parts viewer can produce a data context of the report object 702 (e.g., /Country[USA]/Region[*]) based on the data context of the report object 700. In particular, the report parts viewer can append “*” to the data context of the report object 700 to produce the data context of the report object 702. The report parts viewer can pass the produced data context to the report object 702 to retrieve a relevant instance (or relevant instances) of the report object 702. The report parts viewer can then facilitate display of the relevant instance (or relevant instances) of the report object 702.

In another scenario, the report parts viewer can identify a different data context of the report object 700 (e.g., /Country[Canada]). The report parts viewer can produce a data context of the report object 702 (e.g., /Country[Canada]/Region[*]) based on the different data context of the report object 700 and can pass the produced data context to the report object 702 to retrieve a relevant instance (or relevant instances) of the report object 702. For instance, instead of the chart shown in FIG. 7, the report parts viewer can facilitate display of a chart showing percentage contributions to total sales figures for various regions within Canada.

FIG. 8 illustrates an implementation of drill-down functionality for report objects 800 and 804, which can be included in the same report. Here, the report object 800 corresponds to a map for a particular country (e.g., USA) that includes various target regions (e.g., a target region 802 corresponding to CA), and the report object 804 corresponds to a summary field showing total sales figures for a particular target region (e.g., the target region 802). A report parts tool (e.g., the report parts tool 118) can be used to create a navigation link 806 between the report object 800 and the report object 804. In particular, the report object 804 can be configured as a destination report object (e.g., a drill-down report object) that is associated with the report object 800, and certain report object parameters (e.g., a report URI and a report object name) of the report object 804 can be associated with the report object 800 and stored as a property of the report.

When a user drill-downs from the report object 800, a report parts viewer (e.g., the report parts viewer 122) can identify a data context of the report object 800 (e.g., /Country[USA]) and can produce a data context of the report object 804 (e.g., /Country[USA]/Region[CA]) based on the data context of the report object 800. In the present embodiment, the report parts viewer can identify the target region 802 based on coordinates (e.g., x and y offsets) of the target region 802 as specified by the user. Once the target region 802 is identified, the report parts viewer can append “CA” to the data context of the report object 800 to produce the data context of the report object 804. The report parts viewer can pass the produced data context to the report object 804 to retrieve a relevant instance (or relevant instances) of the report object 804. The report parts viewer can then facilitate display of the relevant instance (or relevant instances) of the report object 804.

In another scenario, the report parts viewer can identify a different target region (e.g., a target region corresponding to NY) specified by the user. The report parts viewer can produce a data context of the report object 804 (e.g., /Country[USA]/Region[NY]) based on the different target region and can pass the produced data context to the report object 804 to retrieve a relevant instance (or relevant instances) of the report object 804. For instance, instead of the summary field shown in FIG. 8, the report parts viewer can facilitate display of a summary field showing total sales figures for NY. In a similar manner as described above, drill-down functionality can be implemented for a report object corresponding to a chart (e.g., the report object 702) based on identifying a particular target region (e.g., a particular “slice”) specified by a user.

Turning next to FIG. 9, an implementation of navigation functionality is illustrated for report objects 900 and 902, which can be included in different reports. The report object 900 corresponds to a group name of a particular product class (e.g., Bicycle), and the report object 902 corresponds to a chart showing percentage contributions to total order amounts for various products (e.g., Descent, Mozzie, Nicros, and Rapel) within a particular product class (e.g., Bicycle). A report parts tool (e.g., the report parts tool 118) can be used to create a navigation link 904 between the report object 900 and the report object 902. In particular, the report object 902 can be configured as a destination report object that is associated with the report object 900, and certain report object parameters (e.g., a report URI and a report object name) of the report object 902 can be associated with the report object 900 and stored as a property of a report. In addition, a data context of the report object 902 can be specified when creating the navigation link 904. Desirably, the data context of the report object 902 can be specified using a formula-based format (e.g., “/”+{Table.Field} or “/”.+{Table.Field}+“/”+{Table.Field}). In the present embodiment, the data context of the report object 902 can be specified as “/”+{Product.Product Class}.

When a user specifies a navigation request for the report object 900, a report parts viewer (e.g., the report parts viewer 122) can identify a data context of the report object 900 (e.g., /Bicycle). The report parts viewer can produce a data context of the report object 902 (e.g., /Bicycle) by applying “Bicycle” to the formula “/”+{Product.Product Class}. The report parts viewer can pass the produced data context to the report object 902 to retrieve a relevant instance (or relevant instances) of the report object 902. The report parts viewer can then facilitate display of the relevant instance (or relevant instances) of the report object 902.

In another scenario, the report parts viewer can identify a different data context of the report object 900 (e.g., /Accessory). The report parts viewer can produce a data context of the report object 902 (e.g., /Accessory) based on the different data context of the report object 900 and can pass the produced data context to the report object 902 to retrieve a relevant instance (or relevant instances) of the report object 902. For instance, instead of the chart shown in FIG. 9, the report parts viewer can facilitate display of a chart showing percentage contributions to total order amounts for various products within the Accessory product class.

FIG. 10 illustrates an implementation of navigation functionality for report objects 1000 and 1002, which can be included in the same report or in different reports. The report object 1000 corresponds to a crosstab showing numbers of suppliers of various product classes (e.g., Accessory and Bicycle) in various countries (e.g., Canada, Japan, UK, and USA), and the report object 1002 corresponds to a chart showing percentage contributions to total order amounts for various products (e.g., Triumph Vertigo Helmet, Outdoors Lycra Glove, and so forth) within a particular product class (e.g., Accessory). A report parts tool (e.g., the report parts tool 118) can be used to create a navigation link 1004 between the report object 1000 and the report object 1002. In particular, the report object 1002 can be configured as a destination report object that is associated with the report object 1000, and certain report object parameters (e.g., a report URI and a report object name) of the report object 1002 can be associated with the report object 1000 and stored as a property of a report. In addition, a data context of the report object 1002 can be specified when creating the navigation link 1004. Desirably, the data context of the report object 1002 can be specified using a formula-based format (e.g., “/”+GridRowColumnValue (“Product.Product Class”), “/”+GridRowColumnValue (“Supplier. Country”), or “/”+GridRowColumnValue (“Product.Product Class”)+“/”+GridRowColumnValue (“Supplier.Country”)).

When a user specifies a navigation request for the report object 1000, a report parts viewer (e.g., the report parts viewer 122) can identify a particular region (e.g., a crosstab row, a crosstab column, or a crosstab cell) of the report object 1000 specified by the user. In particular, the report parts viewer can identify the particular region based on coordinates (e.g., a column value, a row value, or both) of the particular region as specified by the user. The report parts viewer can produce a data context of the report object 1002 by applying a column value, a row value, or both, to a formula specified for the data context of the report object 1002. For instance, the report parts viewer can apply the column value “Accessory” to the formula “/”+{Product.Product Class} to produce the data context of the report object 1002 (e.g., /Accessory). The report parts viewer can pass the produced data context to the report object 1002 to retrieve a relevant instance (or relevant instances) of the report object 1002. The report parts viewer can then facilitate display of the relevant instance (or relevant instances) of the report object 1002.

In another scenario, the report parts viewer can identify a different region (e.g., a region corresponding to the column value “Bicycle”) of the report object 1000 specified by the user. The report parts viewer can produce a data context of the report object 1002 (e.g., /Bicycle) based on the different region and can pass the produced data context to the report object 1002 to retrieve a relevant instance (or relevant instances) of the report object 1002. For instance, instead of the chart shown in FIG. 10, the report parts viewer can facilitate display of a chart showing percentage contributions to total order amounts for various products within the Bicycle product class.

For some embodiments of the invention, implementation of navigation functionality supports firing of events (e.g., server-side events). In particular, before a navigation is carried out, a server-side event can be fired to allow another executable program to control or modify the navigation. For instance, in response to a navigation request, another executable program can acquire a particular data context and perform a database query based on the particular data context. As another example, a report object can be incorporated in a particular web page. When a navigation request is specified for the report object, an event handler code can be applied to route the navigation request to another web page that incorporates a report (e.g., an entire report) that includes the report object.

For certain applications, navigation functionality can be implemented to allow for “forward” and “backward” navigation to facilitate viewing of subsets of various report objects or subsets of various instances of a report object. Such “forward” and “backward” navigation can be implemented in a manner similar to bookmarks in a document. When navigating “forward”, a report parts viewer (e.g., the report parts viewer 122) can configure a data context as a bookmark and can navigate to a data context of a next report object (or a next instance of a report object) in a hierarchy. Similarly, when navigating “backward”, the report parts viewer can configure a data context as a bookmark and can navigate to a data context of a previous report object (or a previous instance of a report object) in the hierarchy.

Navigation functionality as described herein can be effectively applied to a variety of user scenarios, including the rapid development of report aggregations by facilitating linking and use of “child” reports as data sources. For instance, navigation functionality as described herein can be applied to streamline the creation of trending reports or to facilitate navigation to “detail” reports where detail data resides. In addition, navigation functionality as described herein can be applied in conjunction with conventional report viewers, such as conventional page viewers.

It should be recognized that the embodiments of the invention discussed above are merely exemplary, and various other embodiments are encompassed by the present invention.

For instance, in some embodiments of the invention, a report parts viewer can be incorporated in a web page using the following sequence of operations:

1. Create an ObjectFactory object;

2. Declare a path to a report that includes a report object to be displayed;

3. Create a function to output the report to the report parts viewer;

4. Create a CrystalReportPartsDefinition object using the ObjectFactory object and set report parts nodes to those of the CrystalReportPartsDefinition object;

5. Create CrystalReportPartNode objects using the ObjectFactory Object and add CrystalReportPartNode objects to the report part nodes object; and

6. Create a report viewer object using the ObjectFactory object and set a report source and, optionally, other properties of the report parts viewer.

The following provides an example of an Active Server Page (“ASP”) program that implements the sequence of operations:

```
  <%@ Language=VBScript%>
  <% Option Explicit
  Response.ExpiresAbsolute = Now( ) − 1
  ‘ Create the ObjectFactory object.
  Dim objFactory
  Set objFactory = CreateObject(“CrystalReports.ObjectFactory.2”)
  ‘ Declare the path to the report which contains the Report Part
  to be displayed.
  const reportName = “C:\rasw\Product Catalog.rpt”
  Function OutputReport(fileName)
    ‘Sets the report part definitions.
    Dim def
    Set def =
objFactory.CreateObject(“CrystalReports.CrystalReportPartsDefinition”)
    Dim nodes
    set nodes = def.ReportPartNodes
    ‘“ level 1 ”’
    Dim node1
    Set node1 =
objFactory.CreateObject(“CrystalReports.CrystalReportPartNode”)
    node1.Name = “Category”
    nodes.Add (node1)
    ‘“ level 2 ”’
    Dim drillNodes
    set drillNodes =
objFactory.CreateObject(“CrystalReports.CrystalReportPartNodes”)
    Dim node2
    Set node2 =
objFactory.CreateObject(“CrystalReports.CrystalReportPartNode”)
    node2.Name = “ProductTypeName”
    drillNodes.Add(node2)
    node1.DrillDownPath = drillNodes ‘Sets the drill-down path for
    node 1.
    ‘“ level 3 ”’
    Dim drillNodes2
    set drillNodes2 =
objFactory.CreateObject(“CrystalReports.CrystalReportPartNodes”)
    Dim node4
    Set node4 =
objFactory.CreateObject(“CrystalReports.CrystalReportPartNode”)
    node4.Name = “ProductName”
    drillNodes2.Add(node4)
    Dim node5
    Set node5 =
objFactory.CreateObject(“CrystalReports.CrystalReportPartNode”)
    node5.Name = “UnitPrice”
    drillNodes2.Add(node5)
    node2.DrillDownPath = drillNodes2 ‘Sets the drill-down path for
    node 2.
    ‘“ level 4 ”’
    Dim drillNodes3
    set drillNodes3 =
objFactory.CreateObject(“CrystalReports.CrystalReportPartNodes”)
    Dim node6
    Set node6 =
objFactory.CreateObject(“CrystalReports.CrystalReportPartNode”)
    node6.Name = “ProductID”
    drillNodes3.Add(node6)
    Dim node7
    Set node7 =
objFactory.CreateObject(“CrystalReports.CrystalReportPartNode”)
    node7.Name = “Size”
    drillNodes3.Add(node7)
    node4.DrillDownPath = drillNodes3 ‘Sets the drill-down path for
node 4 and node 5.
    node5.DrillDownPath = drillNodes3
    ‘Create a report parts viewer.
    Dim HTMLPartsViewer
    Set HTMLPartsViewer =
    objFactory.CreateObject(“CrystalReports.CrystalReportPartsViewer”)
    ‘Sets properties for the report parts viewer.
    With HTMLPartsViewer
        .ReportSource = fileName
        .ReportParts = def
        .Name = “partproductcat”
        .IsOwnForm = true
        .IsOwnPage = true
        .HasBorder = false
        .RecordNumber = 6
        .IsDisplayHeadings = true
    End With
    ‘Displays the viewer and include error checking in case it fails.
    On Error Resume Next
    call HTMLPartsViewer.ProcessHttpRequest(Request, Response,
    Session)
    if Err.number < > 0 then
        Response.Write Err.Description
        Err.Clear
    end if
  End Function
```

When the ASP program is executed, a report object can be displayed by calling an OutputReport function and passing it to a report path constant:

%>
<HEAD>
<TITLE> Report Parts Sample </TITLE>
</HEAD>
<% OutputReport reportName %>

As another example, an embodiment of the invention may include a help system, including a wizard that provides assistance to users, for configuring a computer network (e.g., the computer network 100) and its various components.

The concepts of the invention may be utilized to facilitate additional functionality. For example, in addition to presenting portions of reports on various computing devices, the portions of reports may also be inserted into existing electronic documents.

Returning to FIG. 1, a report part insertion module 1000 includes a set of executable instructions to select a report from reports 120, select a report part from an existing report (e.g., using the report parts tool 118), and then insert the report part into an electronic document, for example selected from a repository of electronic documents 1002. Ideally, a link between the report part and the original report source is maintained, in accordance with an embodiment of the invention.

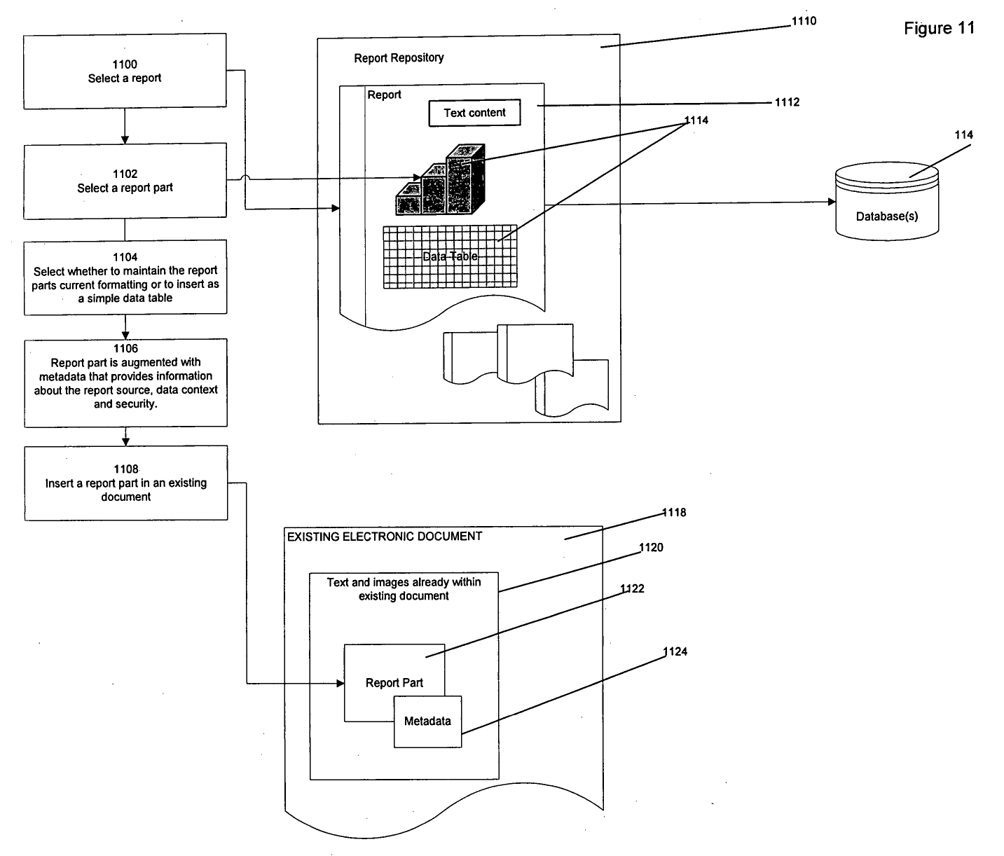

FIG. 11 illustrates processing associated with a report part insertion module 1000 configured in accordance with an embodiment of the invention. In this embodiment, the report part insertion module 1000 includes executable instructions that allow a user to select a report 1100, and then subsequently selects a report part from within that report 1102.

By way of example, FIG. 11 illustrates a report repository 1100 (e.g., corresponding to the reports 120 stored in server 102). A specific report 1112 is selected (e.g., using the report parts tool 118). The reports within the repository are based on data stored in databases 114 that are separate from the report repository. The repository may be a remote repository or reports stored locally on the user's computer. The repository may contain time-stamped instances of reports that contain the same data. Graphical User Interfaces (GUI) to facilitate this process can be available either from the program hosting the document into which the report part will be inserted or a separate program. Additionally, this operation can be performed programmatically without GUI or user input.

A report part 1112 from within the report 1110 is selected (e.g., using the report parts tool 118). After the report part 1114 has been selected, there are options to maintain the report part format (such as a specific chart or table 1114) or to insert the data from the report part as a data table 1104. The report part is augmented with metadata that provides contextual information for the report part including the report source, database connections for the report, and the location of the report part within the larger logic of the report 1106. The report part is then inserted in the existing document 1108. As shown in FIG. 11, the existing document 1118 may contain text, images, other data, 1120 and other inserted report parts.

Thus, as shown in FIG. 11, an existing electronic document 1118 (e.g., from the electronic documents 1002 stored in server 102) has text and images 1120. This content is then supplemented with a report part 1122 (e.g., a report part corresponding to report part 1112). The report part 1122 has corresponding metadata 1124.

An electronic document 1118 can contain multiple report parts 1122 that are either inserted using operations 1100-1108 or are created by copying a report part within or between documents. Each instance (or copy) of the report part 1122 maintains its metadata 1124.

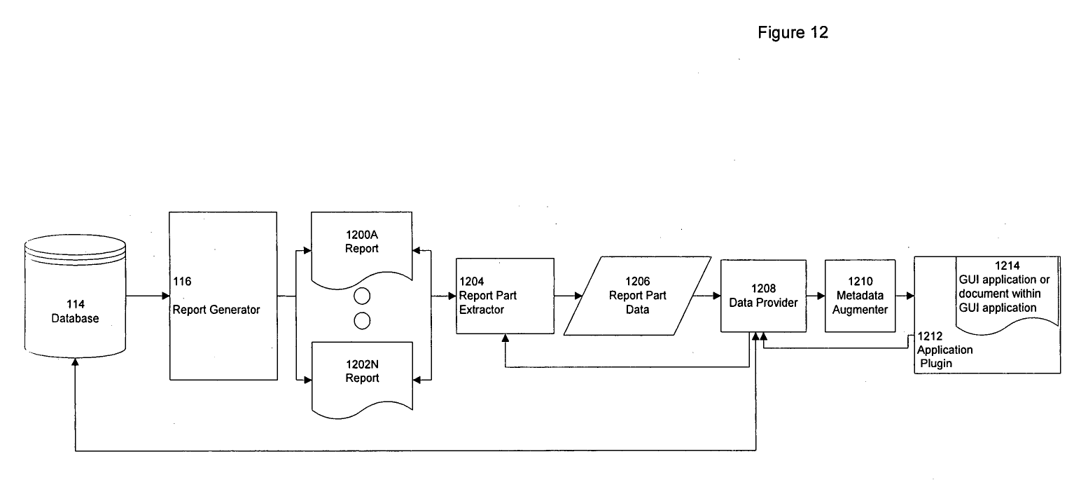

FIG. 12 illustrates an embodiment of the invention used to insert report parts within electronic documents. As previously discussed, a database 114 operates as a data source. Executable instructions associated with a report generator 116 are used to generate a set of reports 1200A through 1200N. A report part extractor 1204 (e.g., executable code associated with the report part insertion module 1000) produces report part data 1206. Observe that the Report Part Extractor 1204 does not access the data in the database 114; rather, the Report Part Extractor 1204 uses the data in the reports 1200A-1200N as a data source. Advantageously, report instances 1200A-1200N may contain specific saved historical data that is not necessarily stored within the database.

In accordance with the invention, the report part insertion module 1000 may include executable instructions forming a data provider 1208 and a metadata augmenter 1210 that operate to insert the report part within an electronic document 1214. The electronic document 1214 may be an existing Graphical User Interface (GUI) application or a document within a GUI application.

In one implementation, the data provider 1208 is based on protocols, such as the Common Object Request Broker Architecture (CORBA), a Component Object Model Dynamic Link Library (COM DLL) or a web service 1208. The report part data 1206 may be constructed such that it maintains formatting from the original report source or so that it is passed as data values.

The Metadata Augmenter 1210 includes executable instructions to add metadata to the report part 1206. In one embodiment, the metadata is inserted as tags (such as Microsoft Smart Tags™ or custom XML tags). In another embodiment, the metadata is stored in an associated table or index. When the data set is inserted in a document or application, the metadata maintains contextual report and data source information that links the inserted data points to the source report and database data 114. This metadata is maintained if the data set is copied to a different location within the same document or is copied from the first document into a second document.

In a preferred embodiment, this metadata includes both data source and report source information, and the report source information includes the report path, group path, and field for the data as well as the data date and data time for the report (time stamp). The metadata is extensible and additional information may be stored in the metadata including security information, data history, comments, data validity, and the last presentation value for the data.

In one embodiment, an application plugin 1212 receives user or programmatic requests to refresh the data set, drill down, and/or change parameters. Based on a request from the application or user, the application plugin passes parameters and any other required information, such as user permissions, to the data provider 1208 which then works with the report part extractor 1204 or directly with the database 114 in order to refresh the data. In one embodiment, the data provider 1208 accesses the database 114 through an enterprise reporting framework that maintains security. The database 114 and report repository 1200A-1200N may be remote or stored locally on the user's computer. Additionally, the user can interact with the inserted report part in order to drill down on data, for example moving from a country level view of the data, to a state level view of the same data, to a city level view of the same data. During drill down the report is accessed and a report part with the more detailed information is provided in the same format as the initial report part that is drilled down on.

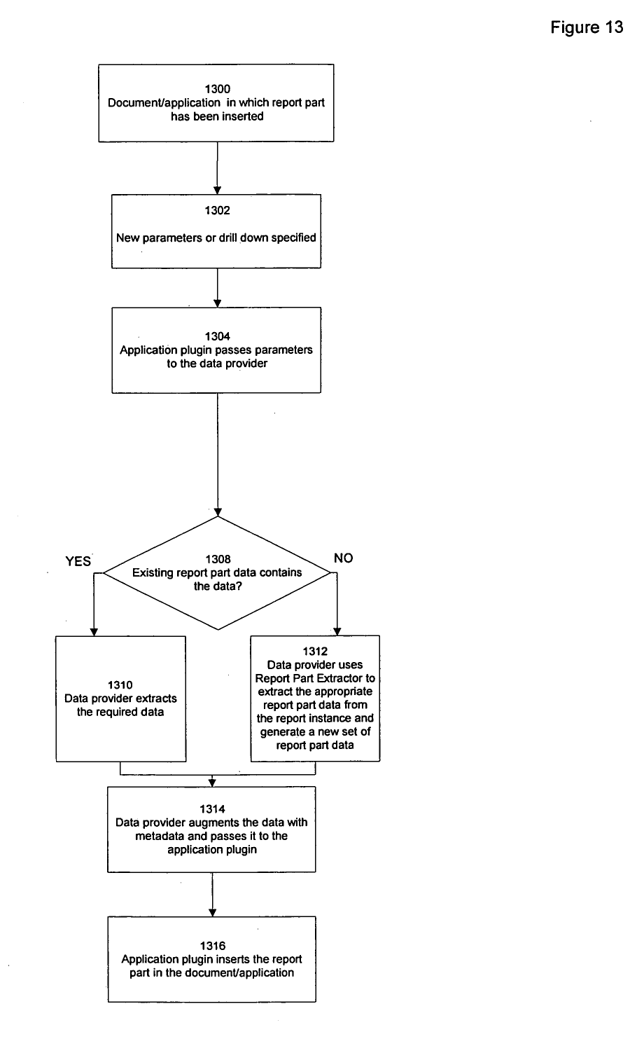

FIG. 13 illustrates processing operations associated with a report part insertion module 1000 that includes executable instructions that allow a report part in an electronic document to be updated with new parameters or drilled down on. Initially, a document with a report part is constructed 1330. When drill down or a change in parameters is specified 1302, the application plugin passes parameters to the data provider 1304. The data provider 1208 analyzes whether the previously constructed report part contains the required data 1308. If so, the data provider 1208 extracts the data 1310 from the report part 1310. If not, the report part extractor 1204 extracts the appropriate report part data from the report instance (e.g., a selected report, such as report 1200A) and generates a new set of report part data 1312.

The data provider 1208 then operates to augment the data with metadata and passes it to the application plugin 1314. The application plugin 1212 subsequently inserts the report part into the electronic document 1316.

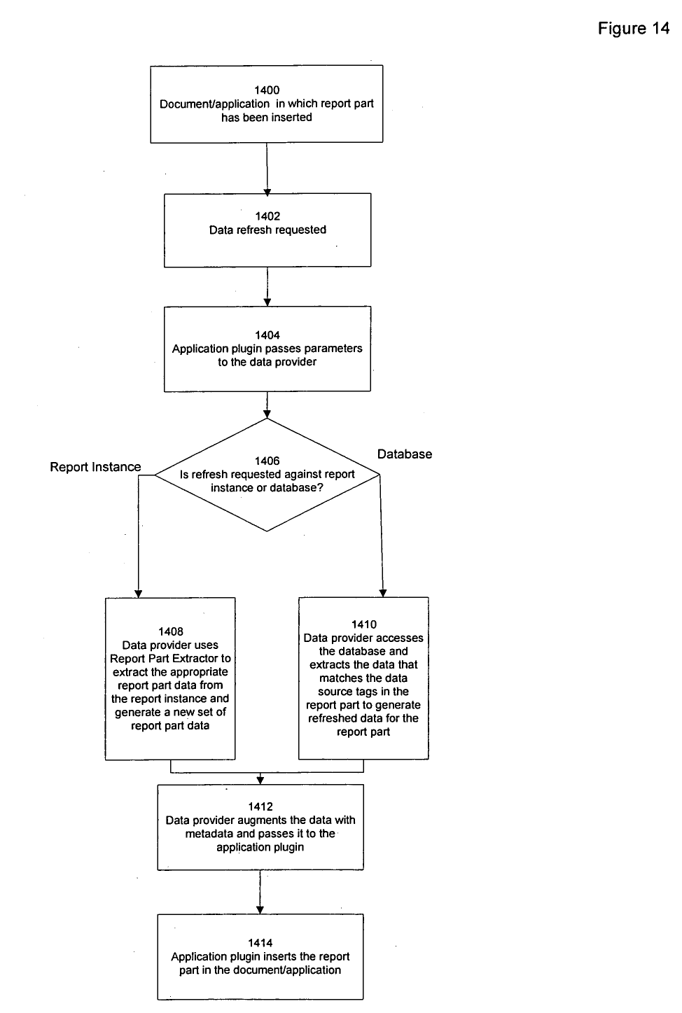

FIG. 14 illustrates processing operations associated with a report part insertion module 1000 that includes executable instructions that allow a report part in an electronic document to have data refreshed either from a report instance or database. Processing begins with an electronic document that has an inserted report part 1400. When a data refresh is requested 1402, the application plugin 1212 passes parameters to the data provider 1208 (1404). A refresh request may be made against either a report instance or the database directly 1406. In a preferred embodiment of the invention, time stamp information identifies the most recent report instance that contains the report part, and this instance is selected to refresh the data in the inserted report part.

In one embodiment of the invention the user selects refresh options when inserting the report part in the document/application. If the refresh is against a report instance, the data provider uses the report part extractor 1204 to extract the appropriate report part from the appropriate report instance 1408. If the refresh is against the database, the data provider accesses the database and extracts the data that matches the data source metadata that had previously been augmented and refreshes the data for the report part against the database 1410. In both cases the data provider augments metadata for the refreshed report part and passes it to the application plugin 1212 (1412). The application plugin 1212 then inserts the report part into the electronic document 1414.

In one embodiment, depending on user preferences or programmatic settings, the original report part may be replaced by the new report part or it may be inserted in a different section of the document/application. In one embodiment, the format of the original report part is maintained and the new data is formatted using the same format. In another embodiment, the user has the option to change the format when changing parameters, drilling down, or requesting a data refresh.

An embodiment of the present invention relates to a computer storage product with a computer-readable medium having computer code thereon for performing various computer-implemented operations. The media and computer code may be those specially designed and constructed for the purposes of the present invention, or they may be of the kind well known and available to those having skill in the computer software arts. Examples of computer-readable media include, but are not limited to: magnetic media such as hard disks, floppy disks, and magnetic tape; optical media such as CD-ROMs and holographic devices; magneto-optical media such as floptical disks; and hardware devices that are specially configured to store and execute program code, such as application-specific integrated circuits (“ASICs”), programmable logic devices (“PLDs”), ROM devices, and RAM devices. Examples of computer code include machine code, such as produced by a compiler, and files containing higher level code that are executed by a computer using an interpreter. For example, an embodiment of the invention may be implemented using Java, C++, or other object-oriented programming language and development tools. Another embodiment of the invention may be implemented in hardwired circuitry in place of, or in combination with, machine-executable software instructions.

While the present invention has been described with reference to the specific embodiments thereof, it should be understood by those skilled in the art that various changes may be made and equivalents may be substituted without departing from the true spirit and scope of the invention as defined by the appended claims. In addition, many modifications may be made to adapt a particular situation, material, composition of matter, method, process step or steps, to the objective, spirit and scope of the present invention. All such modifications are intended to be within the scope of the claims appended hereto. In particular, while the methods disclosed herein have been described with reference to particular steps performed in a particular order, it will be understood that these steps may be combined, sub-divided, or re-ordered to form an equivalent method without departing from the teachings of the present invention. Accordingly, unless specifically indicated herein, the order and grouping of the steps is not a limitation of the present invention.

1. A computer-readable medium comprising executable instructions to:
specify a selected report;
choose a report part from said selected report;
augment said report part with metadata characterizing said report part; and
insert said report part within an electronic document.

2. The computer readable medium of claim 1 said metadata provides information facilitating a link to said selected report.

3. The computer-readable medium of claim 1, wherein said metadata provides information supplying a data context.

4. The computer-readable medium of claim 1, wherein said metadata provides information to coordinate a refresh request for said selected report part.

5. The computer-readable medium of claim 4 wherein said metadata provides information to coordinate a refresh request for said selected report part to said selected report.

6. The computer-readable medium of claim 4 wherein said metadata provides information to coordinate a refresh request for said selected report part to a database.

7. The computer-readable medium of claim 1, wherein said metadata provides security information to preserve security settings from said selected report.

8. The computer-readable medium of claim 2, further comprising executable instructions to facilitate copying of said report part from said electronic document to a secondary electronic document while maintaining said metadata.

9. A computer-readable medium comprising executable instructions to:
select a report part from an existing report;
augment said report part with metadata characterizing a report part source report and data context;
insert said report part within an electronic document; and
refresh data within said report part of said electronic document.

10. The computer-readable medium of claim 9, further comprising executable instructions to facilitate copying of said report part from said electronic document to a secondary electronic document while maintaining said metadata.

11. The computer-readable medium of claim 9, wherein said metadata provides information to coordinate a refresh request to said existing report.

12. The computer-readable medium of claim 9, wherein said metadata provides information to coordinate a refresh request to a database.

13. The computer-readable medium of claim 9, wherein said metadata provides security information to maintain security settings.

14. A computer-readable medium comprising executable instructions to:
generate a set of reports through access to a database;
specify a selected report from said set of reports;
extract a report part from said selected report;
augment said report part with metadata; and
insert said report part within an electronic document.

15. The computer-readable medium of claim 14 wherein said executable instructions to insert said report include an application plugin to insert said report part within said electronic document.

16. The computer readable medium of claim 15 wherein said application plugin includes executable instructions to access a data provider module to facilitate a refresh operation of said report part.

17. The computer readable medium of claim 16 wherein said application plugin includes executable instructions to access a data provider module to facilitate a refresh operation of said report via access to said selected report.

18. The computer readable medium of claim 16 wherein said application plugin includes executable instructions to access a data provider module to facilitate a refresh operation of said report via access to said selected database.
